(19) United States
(12) Patent Application Publication
(10) Pub. No.: US 2026/0097708 A1
(43) Pub. Date: Apr. 9, 2026

(54) EXTRUDED RUNNING BOARD

(71) Applicant: Vintech Industries, Inc., Imlay City, MI (US)

(72) Inventors: James C. Schoonover, III, Shelby Township, MI (US); Kevin J. Weingartz, Imlay City, MI (US)

(73) Assignee: Vintech Industries, Inc., Imlay City, MI (US)

(21) Appl. No.: 19/416,875

(22) Filed: Dec. 11, 2025

Related U.S. Application Data
(63) Continuation-in-part of application No. 18/166,796, filed on Feb. 9, 2023.
(60) Provisional application No. 63/308,274, filed on Feb. 9, 2022.

(51) Int. Cl. B60R 3/00

(52) U.S. Cl. CPC B60R 3/002

(57) ABSTRACT

A multi-layer running board extrusion including a multi-material running board extruded out of a combination of high-performance plastics. The running board is extruded in multiple layers, which optimizes the size and desired performance of the multiple materials to achieve predetermined desired result.

### CROSS-REFERENCE TO RELATED APPLICATIONS

This application is a continuation-in-part application of U.S. patent application Ser. No. 18/166,796, filed Feb. 9, 2023, which claims benefit of United States Provisional Ser. No. 63/308,274, filed Feb. 9, 2022. The disclosures of the above applications are incorporated herein by reference.

### FIELD OF THE INVENTION

The present invention relates to an extruded running board with adjustable running board ribs.

### BACKGROUND OF THE INVENTION

Running boards are generally known. One typical application is a running board that can be attached to a rocker panel of a vehicle or other vehicle body structure. The industry standards are aluminum, chrome aluminum, steel or molded plastics. Weight is just one common problem. Production expenses and high costs are others. Aluminum extrusions are a primary running board. Another is blow molding running boards, which can only be done using one material and requires expensive tooling.

Accordingly, there is a great need for a running board with improved geometry and adjustability to provide a product that is high performance but at a reduced cost.

### SUMMARY OF THE INVENTION

The present invention generally relates to an extruded plastic running board. In accordance with the present invention, there is provided a multi-material running board extruded out of a combination of high-performance plastics. In addition, the running board can be extruded in multi layers which optimizes the size and desired performance of the multiple materials to achieve a desired result. The extruded running board meets predetermined requirements, including predetermined deflection requirements. The present invention allows an extruded running board that is lighter than existing conventional aluminum boards, e.g., generally, at least 5.0 percent lighter, typically at least about 5.0 to 15.0 percent lighter, preferably, about 7.5-8.0 percent lighter. The present invention also allows the extruded running board to be operably cut to any desired length to accommodate various applications and each vehicle platform, e.g., to about 6 feet, about 5 feet, about 3 feet, about 1 foot, or any other suitable length for the particular application, which is another significant advantage over conventional boards.

The present invention provides predetermined running board geometry that incorporates proprietary technology to produce a product that is high performance but at a reduced cost and is lighter weight.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross sectional front elevation view of an extruded running board, in accordance with the present invention;

FIG. 2 is a cross-sectional front elevation view of an extruded running board, in accordance with aspects of the present invention;

FIG. 3 is a cross-sectional front elevation view of an extruded running board, in accordance with aspects of the present invention;

FIG. 4 is a perspective view of FIG. 3; and

FIG. 5 is a cross-sectional front elevation view of an extruded running board, according to aspects of the present invention.

### DETAILED DESCRIPTION OF THE PREFERRED EMBODIMENTS

The following description of the preferred embodiment(s) is merely exemplary in nature and is in no way intended to limit the invention, its application, or uses.

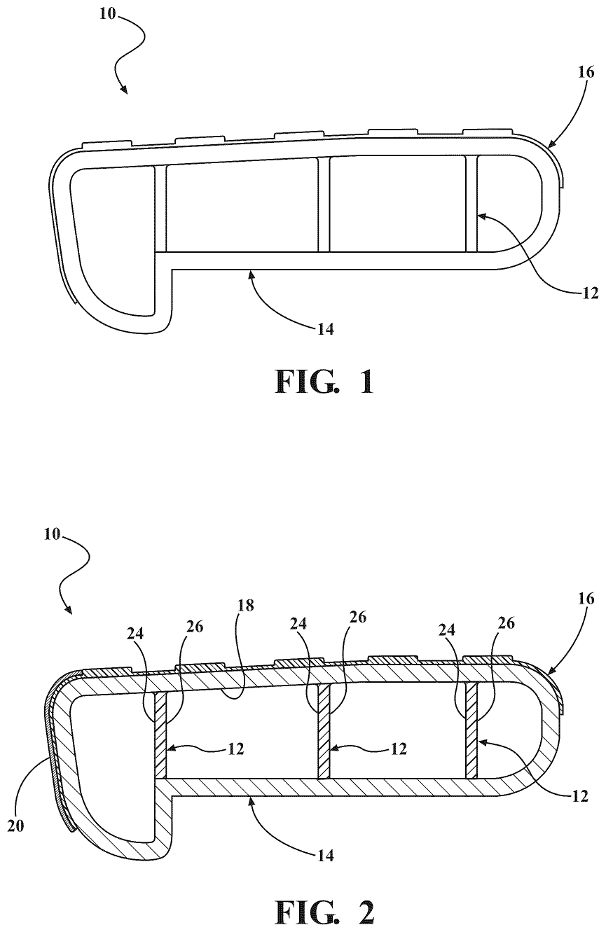

Referring to FIG. 1 generally, in accordance with the present invention, there is provided a multi-material running board extruded out of a combination of predetermined high-performance plastics. In addition, the running board is extruded in a plurality of layers which optimizes the predetermined size and predetermined desired performance of the multiple materials to achieve predetermined desired results (e.g., weight, strength, costs, etc.).

There is provided an extruded running board shown generally at 10, in accordance with the present invention, including a plurality of ribs, indicated generally at 12, and a main body, indicated generally at 14, surrounding the plurality of ribs 12. Most preferably, the main body 14 has a different predetermined material than the plurality of ribs 12. The ribs 12 are generally positioned along the longitudinal length within the main body 14 cavity and are of predetermined length(s) depending on the application, preferably, running substantially the longitudinal length of the main body 14.

The running board has predetermined geometry, especially as to the internal plurality of ribs 12, and incorporates proprietary technology to produce a product that is high performance but at a reduced cost. It is understood that geometry is adapted and suitable for predetermined results depending on the particular applications without departure from the scope of the present invention. By way of non-limiting example, each rib 12 may include at least one integrally formed thicker segment than the remainder of the rib 12.

Extruding in multiple layers optimizes size and desired performance of multiple materials to achieve a desired result. It is understood that the predetermined plurality of materials is suitable for predetermined desired results depending on the particular applications without departure from the scope of the present invention. It is understood that the predetermined size is adapted and suitable for predetermined desired results depending on the particular applications without departure from the scope of the present invention.

Predetermined features provide predetermined desired results, e.g., deflection requirements, wherein the features include but are not limited to, manufacturing process, thickness (e.g., central rib thickness(es) 12, heights, length, and material properties.

The present invention incorporates a plurality of different predetermined materials (e.g., meeting predetermined desired strength and weight requirements) and predetermined varying thickness into the center sections of the profile. By way of non-limiting example, a plurality of thicknesses of various segments of the extruded running board, and different thicknesses depending on the particular applications and predetermined desired properties. According to aspects of the present invention, the extruded running board 10 generally incorporates extruded plastic with a TPV skin coat. The extruded running board 10 typically incorporates reinforced plastic, preferably, glass fiber reinforced polypropylene, more preferably, providing about a 30% glass fiber reinforced polypropylene plastic extrusion with a TPV skin coat.

Preferably, the extruded running board 10 includes the plurality of rib sections 12, e.g., central ribs spanning within the main body 14 of the assembly 10. According to preferred aspects of the present invention, the rib sections 12 thicknesses and material are operably adjustable depending on predetermined performance requirements and particular application (e.g., pickup truck side door(s) running board, cab step, front end step, rear vehicle step, sport utility running board, semi-truck running board, step, military vehicle running board, fixed or deployable running boards, recreational vehicle running board, side cab running board, pickup truck bed step, and etc.

At least one cap layer 16 is operably connected to, or co-extruded with, the main body 14 of the extruded running board 10. The cap layer 16 preferably has a tread design on a step surface for user grip.

The present invention is a multi-material running board 10 extruded out of a combination of predetermined high-performance plastics.

The present invention is unique in that it combines multiple materials to optimize function and minimize cost as well as weight.

The present invention results in light, durable, and functionable running boards.

The present invention provides predetermined extruded running board geometry that incorporates proprietary technology to produce a product that is predetermined high performance but at a reduced cost.

As an all plastic extruded running board 10 body, it is made possible to separate the different areas of the predetermined profile with different predetermined materials creating a unique product.

It is understood that while an extruded running board 10 is shown and described, the present invention is operably adaptable for other components (e.g., any predetermined suitable vehicles, automotive, motor vehicle, mobile home, etc.) depending on the application without departure from the scope of the present invention.

In accordance with the present invention, and referring to FIG. 1 generally, there is provided an all extruded running board 10 and process for manufacturing same. Traditionally, running boards are either metal with plastic components, or molded plastic. Preferably, the running board 10 of the present invention substantially all extruded plastic. Part of what makes this new concept unique is that the present invention is neither molded nor made from metal. It is entirely extruded as one piece. This process makes it unique as it is the only one that solely utilizes the extrusion process to create it. The part 10 is produced by extruding a plurality of different predetermined materials together, e.g., two or three or more different materials together. By utilizing the extrusion process, the part is less costly to process and the cost of tooling is vastly reduced. While this in itself makes it unique to the industry, there are other key features that separate it from traditional running boards. It is extruded with multiple materials allowing for improved performance and aesthetics. The support ribs 12 can be comprised of predetermined reinforced material for strength (e.g., carbon fiber or fiberglass filled polypropylene). The predetermined thickness of these ribs 12 can be adjusted to meet specific weight and performance demands and specific predetermined customer requirements. The top cap 16 can be comprised of a third material (e.g., soft grade TPV/TPO). This would allow for grip, aesthetics, and wear resistance. The soft material is co-extruded on, which would be a far superior bond to that of a metal running board with a soft molded piece snapped or taped on.

By way of non-limiting example, the process provides a tri-durometer extruded running board. According to aspects of the present invention, the plurality of ribs 12, preferably central substantially vertical ribs, are formed of a different material than the main body 14 and/or cap 16, to allow the use of and interchangeability of various predetermined unique materials of the ribs 12 depending on particular applications without changing the other material or the other two materials (triple durometer die).

While three materials are described, it is understood that more or less than three materials is contemplated depending on the application without departure from the present invention. It is understood that suitable materials can be chosen depending on the application without departure from the present invention. It is understood that alternative locations for respective predetermined materials are contemplated depending on the application without departure from the present invention.

The main body 14 may be glass filled polypropylene with TPV about 50 Shore D skin coat, according to aspects of the present invention. According to preferred aspects of the present invention, the main body 14 is filled polypropylene (e.g., having about 60 shore D durometer). The plurality of ribs 12 are preferably the same material as the main body 14, according to aspects of the present invention. Cap layer 16 is preferably scratch resistant TPO (thermoplastic elastomer) or TPV (thermoplastic vulcanizate), e.g., having about 60-95 shore A durometer.

The extruded running board 10 is operably adapted to couple to the vehicle, e.g., using at least one fastener, at least one bolt, at least one mounting bracket, a plurality of metal brackets, etc. According to aspects of the present invention, the extruded running board 10 is operably adapted to be fixed to the vehicle, e.g., with a plurality of metal mounting brackets. The main body 14 is operably adapted to connect to mounting brackets with at least one fastener, e.g., at least one bolt within at least one aperture provided in the main body 14 and corresponding mounting bracket.

In accordance with the present invention, optionally, at least one trim of predetermined material(s) is/are operably connected to the extruded running board 10, (e.g., end cap(s), side trim(s), accent trim, front/rear end caps, molded plastic end caps, 3-dimensional printed end caps, roll-form stainless steel accent trim, stamped accent trim, stamped trim with embossed design and/or silk screening with predetermined graphics and/or colors, extruded trim(s), extruded end caps, and etc.) the extruded running board 10 being operably adapted to connect to the at least one trim depending on the particular application without departure from the scope of the present invention. It is understood that, alternatively the at least one trim is integrally formed with the extruded running board, e.g., with the main body 14. The extruded running board 10, preferably, the main body 14, is adaptable to incorporate at least one fastener for the end caps, e.g., bolts, and/or locating tabs to align and operably couple the end caps to the extruded running board 10, snap fit fasteners, aperture to receive a tab or fastening feature, interlocking channels, adhesive, etc. and any combinations thereof.

Optionally, at least one substantially vertical aero trim, ledge, flange or other suitable aero feature is operably connected to, or integrally formed with, the main body 14 and/or cap 16 of the extruded running board 10. By way of non-limiting example, a substantially vertical upper aero trim to help block or redirect wind flow from entering any gap between the extruded running board 10 and vehicle body for improved vehicle aerodynamics.

In accordance to aspect of the present invention, at least one extruder tool is provided and at least one predetermined cutting tool operably adapted to cut each formed extruded running board to predetermined length depending on the particular application.

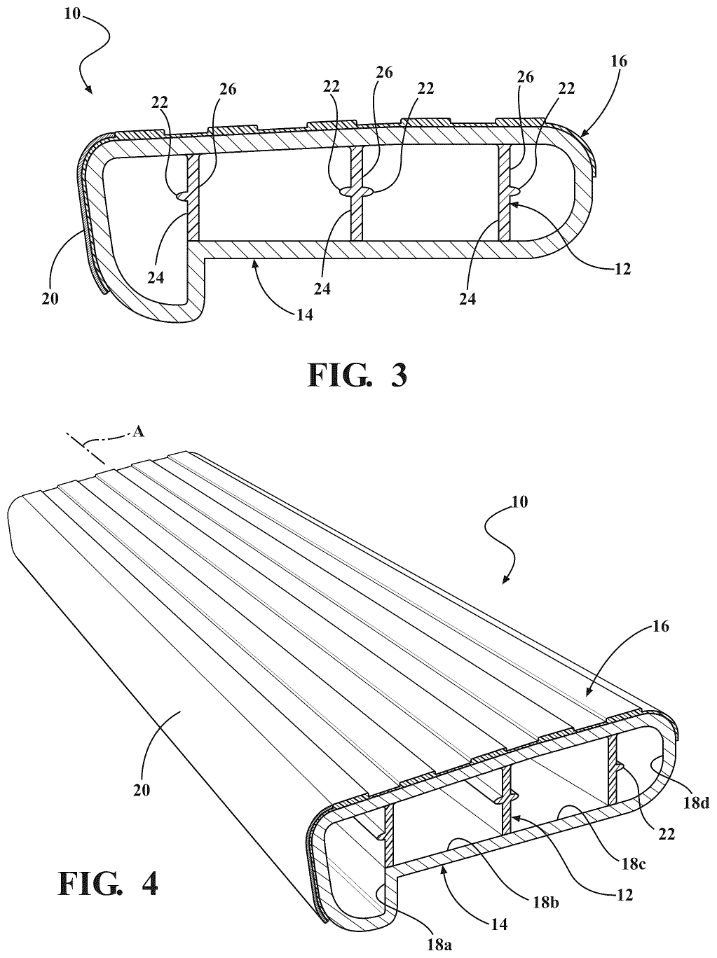

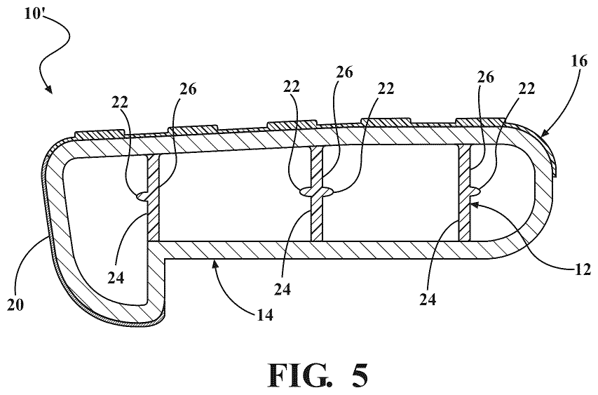

Referring to FIGS. 2-5 generally, there is depicted a multi-material running board and method of making same, including a scratch-resistant layer. The multi-material running board is operably extruded out of a combination of different predetermined materials, in accordance with aspects of the present invention. The extruded running board comprises a plurality of predetermined materials, where at least one provides at least one scratch resistant surface, in accordance with aspects of the present invention. Preferably, the running board is extruded in a plurality of predetermined layers suitable to optimize the predetermined size and predetermined desired performance of the multiple materials to achieve predetermined desired results (e.g., weight, strength, costs, etc.), according to aspects of the present invention. The running board can include at least one reinforcement, e.g., protrusion, located on at least one side of at least one rib or “leg” within a cavity of the body of the running board suitable for predetermined increased strength and performance of the running board. The scratch resistant surface is located at least along the front surface of the running board, preferably extending substantially the longitudinal length of the running board.

The extruded running board is shown generally at 10, in accordance with aspects of the present invention, including at least one rib or “leg”, indicated generally at 12, and a main body, indicated generally at 14, surrounding the plurality of ribs 12. The main body 14 forms an internal cavity 18 enclosed by the inner surface of the main body 14. Each rib 12 substantially extends the longitudinal length ‘A’ of the internal cavity 18 of the main body 14. Preferably, there are a plurality of ribs 12, e.g., three ribs 12. At least one rib 12 divides the cavity 18 at a predetermined location into a plurality of open regions, e.g., at least two open regions or sub-cavities. Preferably, there are at least three ribs 12 at predetermined locations within the cavity 18, dividing the cavity 18 into at least four sub-cavities 18a,18b,18c,18d of predetermined size. Each rib 12 preferably extends substantially the longitudinal length of the main body 14 with respect to axis ‘A’.

Each rib 12 is generally located along the length of the longitudinal axis ‘A’ within the main body 14 cavity 18 and are of predetermined length(s) depending on the particular applications, preferably, running substantially the longitudinal length of the main body 14. The plurality of ribs 12, e.g., preferably at least three, are substantially parallel to each other within the cavity 18 and have a height substantially traverse to the longitudinal axis ‘A’ of the main body 14, extending from body 14 top to bottom walls within the cavity 18. Preferably, the ribs 12 are operably coupled to, e.g., melded with, the inner surface of the main body 14.

The main body 14 can include at least one slip coat of at least one predetermined material(s), e.g., different predetermined material, in accordance with aspects of the present invention.

The least one cap layer 16 is operably extruded or co-extruded on the extruded running board 10, e.g., on the main body 14 outer surface of the extruded running board 10. The cap layer 16 preferably has a predetermined tread design on an upper stepping surface to provide a grip or traction surface.

The extruded running board includes at least one additional surface 20 which is a scratch-resistant surface, in accordance with aspects of the present invention. Preferably, a front show surface. The additional surface 20 (e.g., generally front surface, substantially front surface, etc.) is extruded onto at least one predetermined surface of the extruded running board 10. Preferably, operably extruded on at least the front, e.g., outward longitudinal side, of the extruded running board 10. The at least one additional surface 20 engages the main body 14, or on the front of the main body 14 and over a outer front flap of the cap layer 16, and/or abuts an end of the cap layer 16, etc. Preferably, the cap layer 16 and additional surface 20 are co-extruded to the main body 14.

The additional surface 20 is a different material than the main body 14, ribs 12, and cap layer 16. According to aspects of the present invention, there are at least four materials provided.

The main body 14 is comprised of a predetermined first material, preferably a mineral filled polypropylene. The first material typically has about 70 to about 85 Shore D hardness, preferably from 70 to 85 Shore D.

According to aspects of the present invention, the outside material, e.g., main body 14 material, is mineral filled polypropylene. It could overlap with a Shore D hardness of another material; however, the first material will have different predetermined benefits because of the mineral filler including, but not limited to, predetermined structure, length stability, and improved surface, e.g., show surface, profile(s), tolerances, bonding surface for co-extruded features, bonding with extrusions delivered from a die when heated, etc.

The plurality of support ribs 12 are comprised of a different predetermined second material, typically a predetermined reinforced material for strength, preferably a fiberglass filled polypropylene. The second material typically has about 70 to about 85 Shore D hardness, preferably from 70 to 85 Shore D. While polypropylene typically has from 70 to 85 Shore D, one of the differences is the structural strength that the second material benefits from the fiberglass.

Preferably, the main body 14 and plurality of ribs 12 are co-extruded and coupled together where the ribs 12 meet the inner surface of the main body 14, e.g., co-extruded at a predetermined heated temperature making the molten or otherwise heated materials meld together at the surfaces where the materials are brought into engagement with each other.

The cap layer 16 is comprised of a different predetermined third material, e.g., TPV, TPO). The cap layer 16 preferably operably allows for at least predetermined grip performance, aesthetics, and wear resistance. The predetermined third material is extruded onto at least the main body 14, e.g., as a substantially top layer, which is a far superior bond to that of a metal running board with a soft molded piece snapped or taped on. The cap layer 16 can be a scratch resistant material or a softer slip resistant elastomeric material, according to aspects of the present invention.

The additional surface 20 is comprised of a predetermined fourth material that is an extrudable scratch-resistant material, generally a predetermined hard thermoplastic polyolefin (TPO) or TPE, typically TPE. Preferably, the fourth material has about 60-75 Shore D. Most preferably TPE, which benefits include being scratch resistant, good show surface, chemical resistant, color matching, and UV stabilized.

In accordance with aspects of the present invention, at least one reinforcement 22, e.g., reinforcement rib, protrusion, bump, bulge, ribbing, flange, angled rib, horizontal flange, aligned protrusions, offset protrusions, parallel protrusions, etc., is located on at least one side 24 of at least one rib 12 or “leg” within the cavity 18 of the main body 14 of the extruded running board 10 suitable for predetermined increased strength and performance of the running board. The reinforcement 22 is a predetermined material that is same or different material as the rib 12, preferably, the same or different material as the rib 12.

The predetermined thickness of the ribs 12 can be operably adjusted to meet specific weight and performance demands and specific predetermined customer requirements. It is understood that the thicknesses of a plurality of ribs may be different from each other depending on the particular application without departure from the scope of the present invention.

The running board has predetermined geometry, especially as to the internal plurality of ribs 12, and incorporates proprietary technology to produce a product that is high performance but at a reduced cost. It is understood that geometry is adapted and suitable for predetermined results depending on the particular applications without departure from the scope of the present invention. By way of non-limiting example, each rib 12 may include at least one thicker segment than the remainder of the rib 12.

According to aspects of the present invention, the assembly 10 is operably extruded in multiple layers, optimizing predetermined size and desired performance of the multiple materials to achieve predetermined desired result. It is understood that the predetermined plurality of materials is suitable for predetermined desired results depending on the particular applications without departure from the scope of the present invention. It is understood that the predetermined size is adapted and suitable for predetermined desired results depending on the particular applications without departure from the scope of the present invention.

Predetermined plurality of features provide predetermined desired results, e.g., deflection requirements, strength, object strikes, etc., wherein the features include but are not limited to, manufacturing process, e.g., extruded, co-extruded, extruded in layers, etc., thickness (e.g., central rib thickness(es) 12, heights, e.g., main body cavity height, thickness, cavity size, etc., length, and plurality of materials properties.

The present invention incorporates a plurality of different predetermined materials (e.g., meeting predetermined desired strength and weight requirements) and, optionally, predetermined varying thickness into the center sections of the profile, according to aspects of the present invention. By way of non-limiting example, a plurality of thicknesses of various segments of the extruded running board, and different thicknesses depending on the particular applications and predetermined desired properties.

The predetermined materials of the main body 14, plurality of ribs 12, cap layer 16, and scratch-resistant layer 20 are each different from each other.

According to aspects of the present invention, the extruded running board 10 generally incorporates extruded plastic, typically extruded plastic with a TPV skin coat, preferably extruded reinforced plastic. The extruded running board 10 more preferably incorporates reinforced plastic, e.g., at least the main body 14, generally, glass fiber reinforced polypropylene, typically about 25 to 45% glass fiber reinforced polypropylene, preferably, about 28 to 35% glass fiber reinforced polypropylene, more preferably about a 30% glass fiber reinforced polypropylene plastic extrusion, and most preferably about a 30% glass fiber reinforced polypropylene plastic extrusion and a TPV skin coat. The skin coat is at least the cap layer 16, according to aspects of the present invention.

Preferably, the extruded running board 10 includes the plurality of rib sections 12, e.g., central ribs spanning substantially the length within the main body 14 cavity 18 of the assembly 10. According to preferred aspects of the present invention, the rib sections 12 thicknesses and material are operably adjustable depending on predetermined performance requirements and particular application (e.g., pickup truck side door(s) running board, cab step, front end step, rear vehicle step, sport utility running board, semi-truck running board, step, military vehicle running board, fixed or deployable running boards, recreational vehicle running board, side cab running board, pickup truck bed step, and etc.

A multi-material running board 10 extruded out of a combination of predetermined high-performance plastics is provided, in accordance with aspects of the present invention.

There is provided unique combinations of predetermined multiple materials to optimize function and minimize cost as well as weight, in accordance with aspects of the present invention.

Advantages include results in light, durable, and functionable running boards suitable to meet predetermined requirements depending on the particular applications, in accordance with aspects of the present invention.

According to aspects of the present invention, there is provided predetermined extruded running board geometry that incorporates predetermined proprietary technology suitable to operably produce a product that is predetermined high performance but at a reduced cost.

In accordance with aspects of the present invention, as an all-plastic extruded running board 10, it is made possible to separate the different areas of the predetermined profile of the assembly 10 with a plurality of different predetermined materials creating a unique product.

It is understood that while an extruded running board 10 is shown and described, the present invention is operably adaptable for other components (e.g., any predetermined suitable vehicles, automotive, motor vehicle, mobile home, etc.) depending on the application without departure from the scope of the present invention.

In accordance with aspects of the present invention, and referring to FIG. 2-5 generally, there is provided an all-extruded running board 10 and process for manufacturing same. Traditionally, running boards are either metal with plastic components, or molded plastic. The extruded running board 10 of the present invention is predetermined extruded plastic. Part of what makes this new concept unique is that the present invention is neither molded nor made from metal. It is entirely extruded as one piece. This extruded running board 10 and process for manufacture makes it unique as it is the only one that solely utilizes the extrusion process to create it.

The extruded running board 10 is produced by extruding a plurality of different predetermined materials together. By utilizing the extrusion process, the part is less costly to process, and the cost of tooling is vastly reduced, e.g., compared to molded and metal parts. While this in itself makes it unique to the industry, there are other key features that separate it from traditional running boards. It is extruded with predetermined multiple materials allowing for improved performance and aesthetics. The extruded running board 10 in accordance with the present invention comprises a main body 14, at least one rib 12, cap layer 16, and at least one additional surface 20.

The additional surface 20 is on at least one show side, e.g., the outside show surface face of the extruded running board 10.

By way of non-limiting example, the process provides at least a multi-durometer extruded running board. Any number of durometers are contemplated depending on the particular applications without departure from the scope of the present invention. According to aspects of the present invention, the plurality of ribs 12 are formed of a different material than the main body 14, cap 16, and additional surface 20, to allow the use of and interchangeability of various predetermined unique materials of the ribs 12 depending on particular applications without changing the other predetermined materials, which are themselves preferably all different.

While at least four predetermined materials are described, it is understood that more than four predetermined materials are contemplated depending on the application without departure from the present invention. It is understood that a plurality of suitable materials can be chosen depending on the particular applications without departure from the present invention. It is understood that alternative locations for respective predetermined materials are contemplated depending on the application without departure from the present invention.

The extruded running board 10 is operably adapted to couple to the vehicle, e.g., using at least one fastener, at least one bolt, at least one mounting bracket, a plurality of metal brackets, etc., and any combinations thereof. According to aspects of the present invention, the extruded running board 10 is operably adapted to be fixed to the vehicle, e.g., with a plurality of metal mounting brackets. Alternatively, the extruded running board 10 is operably adapted to be mounted to be selectively movable between a stepping position and stored position. The main body 14 is operably adapted to connect to mounting brackets with at least one fastener, e.g., at least one bolt within at least one aperture provided in the main body 14 and corresponding mounting bracket, in accordance with aspects of the present invention. Preferably, the underside of the main body 14 is operably mountable to the mounting brackets. Preferably, the cap layer 16 and upper side of the main body 14 have no apertures for mounting or otherwise connecting to the vehicle. By way of non-limiting example, the extruded running board 10 is operably adapted to operably mount to the rocker panel or generally behind the rocker panel of the vehicle.

In accordance with the present invention, optionally, at least one trim of predetermined material(s) is/are operably connected to the extruded running board 10, (e.g., end cap(s), side trim(s), accent trim, front/rear end caps, molded plastic end caps, 3-dimensional printed end caps, roll-form stainless steel accent trim, stamped accent trim, stamped trim with embossed design and/or silk screening with predetermined graphics and/or colors, extruded trim(s), extruded end caps, etc., and any combinations thereof) the extruded running board 10 being operably adapted to connect to the at least one trim depending on the particular application without departure from the scope of the present invention. It is understood that, alternatively, the at least one trim is integrally formed with the extruded running board, e.g., with the main body 14.

It is understood that the extruded running board 10 is any predetermined length depending on the particular applications without departure from the scope of the present invention. By way of non-limiting example, the board 10 is operably cut to length for a 2-door vehicle, while operably cut to a longer predetermined length for a 4-door vehicle, and/or pickup truck, etc. The main body 14 is preferably open at both ends, allowing for continuous parts cut to any predetermined desirable length depending on the particular application. End caps or other predetermined part(s) can be operably connected at both ends of the main body, thereby closing off both ends of the cavity 18.

The extruded running board 10, preferably, the main body 14, is adaptable to incorporate at least one fastener or fastener means for the end caps, e.g., bolts, screws, rivets, barbed rivet, etc., and/or locating tabs to align and operably couple the end caps to the extruded running board 10, snap fit fasteners, aperture to receive a tab or fastening feature, interlocking channels, self-piercing screws, adhesive, welding, etc. and any combinations thereof. Preferably, the end caps would be aligned to the main body 14 and fit over both ends of the extruded running board 10.

Optionally, at least one substantially vertical aero trim, ledge, flange or other suitable aero feature is operably connected to, or integrally formed with, the main body 14 and/or cap 16 and/or additional surface 20 of the extruded running board 10. By way of non-limiting example, a substantially vertical upper aero trim to help block or redirect wind flow from entering any gap between the extruded running board 10 and vehicle body for improved vehicle aerodynamics.

In accordance with aspects of the present invention, at least one extruder tool is provided to extrude the plurality of predetermined materials, and at least one predetermined cutting tool operably adapted to cut each formed extruded running board to predetermined length depending on the particular application.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An extruded running board, comprising:
a plurality of central ribs of at least one predetermined reinforcing material;
a plurality of predetermined extrudable materials operably extruded into a plurality of layers operably forming at least one main body of said extruded running board and a front show surface, and wherein at least one of said plurality of predetermined extrudable materials forms said plurality of central ribs.

2. The extruded running board of claim 1, wherein said extruded running board is operably adapted to be mountable to a vehicle.

3. The extruded running board of claim 1, wherein said plurality of central ribs have a predetermined thickness that is operably adapted to meet predetermined weight and performance demands.

4. The extruded running board of claim 1, wherein said main body includes a cavity with an inner surface, said central ribs within said cavity, wherein both ends of each of said central ribs are melded with said inner surface of said main body.

5. The extruded running board of claim 1, wherein said main body is a mineral filled polypropylene.

6. The extruded running board of claim 5, wherein said main body has about 70 to about 85 Shore D hardness.

7. The extruded running board of claim 6, wherein said plurality of central ribs is a fiberglass filled polypropylene.

8. The extruded running board of claim 7, wherein said front show surface is a scratch-resistant material.

9. The extruded running board of claim 7, wherein said front show surface is a thermoplastic elastomer.

10. The extruded running board of claim 9, wherein said front show surface is about 60-75 Shore D.

11. The extruded running board of claim 7, further comprising a cap layer, wherein said cap layer is a thermoplastic polyolefin or thermoplastic vulcanizate.

12. An extruded running board adapted for a vehicle, comprising:
a main body with a longitudinal cavity;
a plurality of ribs located within the cavity and forming a structure with the main body;
a cap layer over an outward upper surface of said main body; and
at least one scratch-resistant layer.

13. The extruded running board of claim 12, wherein said plurality of ribs have a predetermined thickness and at least one shape that are operably adjustable to meet predetermined weight and performance demand variables.

14. The extruded running board of claim 12, wherein there are at least three of said plurality of ribs located within at least one cavity of said main body, and said plurality of ribs extend substantially along a longitudinal direction of said main body.

15. The extruded running board of claim 12, wherein the scratch-resistant layer is a show-surface on the outward side of the extruded running board.

16. The extruded running board of claim 12, wherein said main body is a mineral filled polypropylene and has about 70 to about 85 Shore D hardness.

17. The extruded running board of claim 16, wherein said plurality of central ribs is a fiberglass filled polypropylene.

18. The extruded running board of claim 17, wherein said front show surface is a thermoplastic elastomer.

19. The extruded running board of claim 18, wherein said cap layer is a thermoplastic polyolefin or thermoplastic vulcanizate.

20. A vehicle extruded running board, comprising:
a plurality of materials that are predetermined materials extruded into a plurality of layers operably forming at least said main body of said extruded running board and said plurality of ribs.
an extruded main body of a first material and including a central cavity surrounded by an inner surface of the main body;
a co-extruded plurality of ribs of a second material located within the cavity and forming a structure with the main body;
an extruded cap layer of a third material over an outer surface of said main body; and
a co-extruded additional layer of a fourth material that is a scratch-resistant layer over a forward longitudinal side of said main body and in abutting engagement to an end of said cap layer.
